(19) United States
(12) Patent Application Publication
(10) Pub. No.: US 2026/0258906 A1
(43) Pub. Date: Sep. 3, 2026

(54) STORAGE CONTAINER FOR CRYOGENIC LIQUID, WATERCRAFT WITH A CORRESPONDING STORAGE CONTAINER AND METHOD FOR STORING A CRYOGENIC LIQUID

(71) Applicant: LINDE GMBH, Pullach (DE)

(72) Inventors: Anton WELLENHOFER, Pullach (DE); Jürgen BICHLMEIER, Pullach (DE); Stefan FELBINGER, Pullach (DE); Harald ZENZ, Pullach (DE); Petya TONEVA, Pullach (DE)

(21) Appl. No.: 18/837,014

(22) PCT Filed: Feb. 7, 2023
(86) PCT No.: PCT/EP2023/025054

§ 371 Date: Aug. 8, 2024

(30) Foreign Application Priority Data
Feb. 14, 2022 (EP) 22020050.5

(51) Int. Cl. F17C 3/08; B63B 25/12

(52) U.S. Cl. CPC F17C 3/08; B63B 25/12; F17C 2201/0109; F17C 2201/032; F17C 2201/035; F17C 2203/012; F17C 2203/0391; F17C 2203/0629; F17C 2221/011; F17C 2223/0161; F17C 2270/0105

(57) ABSTRACT

A storage container for a cryogenic liquid which has a container interior in which an extraction region for the liquid is formed, wherein an extraction opening for the liquid is arranged in the extraction region. The extraction region is separated from the container interior by means of an at least partly non-perforated shielding wall such that liquid through-openings are formed. From a separated space, an extraction line can be guided out vertically downwards or to the side. The invention also relates to a corresponding watercraft and a corresponding method for storing liquid hydrogen.

The invention relates to a storage container for a cryogenic liquid, a watercraft with a corresponding storage container, and a corresponding method for storing a cryogenic liquid.

### BACKGROUND

As described in WO 2021/204419 A1 of the applicant, storage containers for liquid hydrogen can, for example, have a cylinder-shaped geometry with a tubular base portion and two domed end-cap portions that close the ends of the base portion. In maritime applications of such storage containers, movement of the liquid hydrogen caused by swell must be expected in the storage container. In the event that the storage container is arranged lying or vertically, the mass inertia of the liquid hydrogen and the existing curvature of the storage container, both on its base portion and on the end-cap portions, can result in the sloshing of the liquid hydrogen in a large area. This sloshing can result in various disadvantages, which are also explained below.

From DE 10 2012 207 575 A1, a method for supplying a pump with cryogenic liquid and a device and a container for carrying out the method are known. In order to achieve reliable supply to a pump, the container is pressurized for improved withdrawal.

A propellant tank proposed in US 2018/072436 A1 includes a tank body that accumulates therein the propellant in a liquid state, and a holding container that is provided inside the tank body and arranged with a predetermined gap from an inner wall of the tank body, so that the propellant can be held therein in a liquid state when the inside of the tank body is in a state of low gravity.

From U.S. Pat. No. 5,901,557 A, a container for storing a cryogenic fluid is known, the container having a passive thermodynamic venting system for effectively transferring heat in a reduced-gravity environment. The storage container is compartmentalized using a screen trap so that the heat exchanger of the venting system extends through a chamber which includes only the liquid phase of the cryogenic fluid. A screen gallery, screen trap and vane assembly cooperate to separate the gas and the liquid phases of the cryogenic fluid. The thermodynamic venting system comprises a throttle apparatus for reducing the temperature of cryogenic fluid.

U.S. Pat. No. 3,933,448 A discloses a surface tension device for use in a liquid acquisition reservoir. The surface tension device comprises: a porous membrane that maintains a separation between gas and liquid and thereby isolates accumulated gas from the liquid acquired and subsequently delivered free of entrained gases; and a porous baffle held spaced apart from the vessel wall and establishing a liquid acquisition chamber separated from the liquid storage chamber and wherein pure liquid is acquired and subsequently withdrawn through an opening. The baffle is characterized by a ski-shape. As a result of the ski-shape, substantially complete acquisition of the available liquid from the reservoir can be assured.

Against this background, the object of the present invention is that of improving the storage of cryogenic liquids such as liquid hydrogen, in particular on ships.

### DISCLOSURE OF THE INVENTION

Against this background, a storage container for a cryogenic liquid, a watercraft with a corresponding storage container, and a corresponding method for storing a cryogenic liquid are proposed. Embodiments of the invention are the subject matter of the dependent claims and the description below.

The storage container for a cryogenic liquid proposed according to the invention comprises a container interior from which an extraction region for liquid is separated. An extraction opening for the liquid is formed in the extraction region. According to the invention, the extraction region is separated from the container interior by means of a shielding wall such that liquid through-openings are kept clear, the shielding wall being at least in portions non-perforated.

The non-perforated, and thus fluid-impermeable, design of the shielding wall can be achieved in particular by providing the shielding wall, as a whole or at least in the corresponding portions, in the form of a flat material, in particular a metal sheet of suitable thickness, or by connecting a plurality of flat materials, in particular a plurality of metal sheets. The connection can be made in particular by welding. The term “non-perforated in portions” should be understood here to mean in particular that one or more sub-areas of the shielding wall are non-perforated. The shielding wall may be suitably shaped, in particular to increase its stability or by adapting it to a container shape. The shielding wall may be, at least in the mentioned portions, non-screen-shaped and/or without bores, slots, holes or through-openings of any kind, all of which are to be considered to fall under the term “perforation” in the sense understood here. A “non-screen-shaped” design in the language usage understood here should be considered to exist in particular also when a corresponding wall is not designed in the form of a grid made of woven or connected wire-shaped or rod-shaped material or with regularly arranged holes. In particular, the shielding wall can be non-perforated and thus liquid-impermeable in more than 50%, 60%, 70%, 80% or 90% of its (total) area.

The present invention differs in particular by the provision of the non-perforated shielding wall from disclosures such as DE 10 2012 207 575 A1, US 2018/072436 A1, U.S. Pat. Nos. 5,901,557 A and 3,933,448 A, which concern other fields of technology and also necessarily require a perforated or screen-shaped element for the respective proposed solutions. By providing a non-perforated shielding wall, stability can be increased and, if necessary, the shielding wall can be used as a structural element. Furthermore, production becomes easier and more cost-effective.

In embodiments of the present invention, the extraction opening can be an inlet opening of an extraction line that is guided out of the storage container inside or outside the extraction region, either vertically downwards or in a lateral direction. In other embodiments of the present invention, the extraction opening can also be a discharge opening in a container wall in the extraction region. In this way, the present invention can be used both in the case of horizontally arranged storage containers and in the case of vertically arranged storage containers.

The present invention makes it possible in particular, in corresponding embodiments, to prevent a negative effect of the sloshing mentioned above, which consists in the fact that, in the case of sufficiently large sloshing movements, gas can enter the extraction opening and remain there (so-called entrainment). In this case, purely liquid extraction of the cryogenic liquid is not possible. The present invention overcomes this disadvantage by simple means. While according to the prior art, in order to avoid the sloshing movements, installations such as bulkheads or baffles in horizontal and/or radial design, for example in the form of a honeycomb structure, are typically provided as such throughout the interior of a corresponding container, the present invention allows for the mitigation of the negative effects with simpler technical means.

Another solution known from the prior art for preventing entrainment is the use of a tight wall surrounding the extraction opening and having a certain height. However, this has the disadvantage that a certain liquid level is always required in a corresponding container (higher than the wall height) and therefore complete emptying is not possible. The present invention also overcomes this disadvantage.

The term “cryogenic liquid” is understood to mean in particular a liquefied gas with a boiling point (significantly) below −100° C., for example liquefied noble gas, liquefied hydrogen, liquefied oxygen or liquefied methane or natural gas. Therefore the invention, although predominantly described with reference to liquid hydrogen, is not limited thereto. However, suitability in particular for liquid hydrogen results from its low density of only approximately 70 kg/m³, compared e.g. to 1,000 kg/m³ for water, which makes liquid hydrogen particularly easy to set in motion.

Overall, the invention prevents entrainment of gas by the liquid extraction and enables optimized use of the entire interior of a corresponding storage container. Compared to installations known from the prior art, the solution provided according to embodiments of the present invention is more space-saving and lighter. Only local two-phase states which could lead to disadvantages in downstream method steps or equipment must be avoided. As mentioned, a non-perforated wall offers advantages with respect to production, stability and cost.

In one embodiment of the invention, it is provided that the storage container has a cylindrical portion, wherein the shielding wall is provided in at least a part of the cylindrical portion. In this case, the extraction region can be separated, as a cylinder segment, from the container interior by means of the shielding wall. The shielding wall can contact the cylinder-shaped portion on two parallel sides. On these sides, the shielding wall, which can be flat in particular, but can also be domed, can in particular be connected, in particular welded, to the wall of the cylinder-shaped portion. In this way, it can be ensured that liquid in the region separated by the shielding wall, i.e. in a corresponding cylinder segment, does not “slosh along” with the rest of the liquid in the container. This keeps the separated region filled with liquid so that no gas can enter the extraction opening. By appropriate welding and selection of the thickness of the shielding wall, the latter can also form a structural or reinforcing element of the storage container as a whole.

If, in a corresponding embodiment, an outlet opening or withdrawal opening is provided in the extraction region and the extraction region is in the form of a cylinder segment, the outlet opening or withdrawal opening can be provided in particular in a region of a vertex line of the cylinder segment. If reference is made here to an arrangement of the outlet opening “in a region of a vertex line of the cylinder segment”, this is to be understood as meaning that the outlet opening does not have to be arranged directly on or at the vertex line, but can also be offset from it in a certain region. In any case, however, the outlet opening is located inside the separated cylinder segment.

The separation of a cylinder segment from a cylindrical region of the storage container can be provided in particular in the case of a horizontal arrangement. In a vertical design, a domed tank bottom can be separated according to the same principle. In both cases, the advantages of the invention arise substantially in the same way.

In one embodiment of the invention, in particular when a cylinder segment is separated from a cylindrical portion, it is provided in particular that the shielding wall is connected to a container wall of the storage container by means of a plurality of mutually parallel fastening walls. In the case of the cylinder-shaped portion and a separation of a cylinder segment, the fastening walls can in particular be arranged perpendicular to its central axis and connected to the container wall in the cylinder segment. The fastening walls can in particular be designed in the manner of partition walls with suitable passages which chamber the extraction region and allow an exchange of liquid between the chambers.

In one embodiment of the invention, it can be provided in particular that the fastening walls are in the form of incomplete circle segments, which in particular define chambers arranged one behind the other along the central axis of the extraction region and leave passages clear between the chambers. In the case of the separation of a cylinder segment in the manner explained above, these fastening walls can in particular leave passages between the chambers clear alternately on the first and the second of the two sides arranged parallel to the central axis. Through the alternating through-openings on both sides, the liquid can distribute itself between the formed chambers, but is retained overall in the extraction region.

In one embodiment of the invention, it is provided that the fastening walls define an at least partially meandering interior of the extraction region. Due to the meandering design of the interior, the retention of liquid in the cylinder segment or in a differently shaped extraction region is ensured in a particularly effective manner in accordance with the embodiment just explained.

In one embodiment of the invention, it is provided that the storage container is closed at both ends by hemispherical or dome-shaped portions, as is generally known for corresponding tanks. Even the negative effects of sloshing movements that can occur at corresponding ends can be reliably prevented in embodiments of the invention.

In one embodiment of the invention, the storage container has a double wall which is designed for vacuum insulation.

A watercraft with a storage container such as was previously explained in different embodiments is also the subject matter of the present invention. The cylinder-shaped portion can be arranged horizontally or vertically. The extraction opening can be guided out vertically downwards or to the side. With regard to additional features and advantages, reference is expressly made to the explanations above regarding the storage container and its embodiments, since these likewise concern a corresponding watercraft.

The same also applies, mutatis mutandis, to a method for storing liquid hydrogen, in which a storage container such as was previously explained in embodiments is used, in particular in a corresponding watercraft.

The invention and embodiments thereof are explained in more detail below with reference to the attached drawings.

### BRIEF DESCRIPTION OF THE DRAWINGS

FIG. 1 illustrates a watercraft according to an embodiment of the invention.

FIGS. 2A and 2B illustrate a storage container according to an embodiment of the invention in a schematic longitudinal view.

FIGS. 3A and 3B illustrate a storage container according to an embodiment of the invention in a schematic perspective view.

In the figures, components corresponding functionally or structurally to one another are indicated by identical reference signs, and only for the sake of clarity are not repeatedly explained.

### DETAILED DESCRIPTION OF THE DRAWINGS

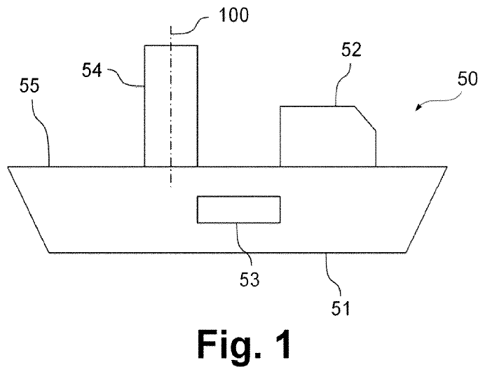

FIG. 1 shows a simplified schematic representation of a watercraft according to an embodiment of the present invention, the watercraft being designated as a whole by 50. In particular, the watercraft 50 can be a maritime passenger ferry.

The watercraft 50 comprises a hull 51 that is buoyant. Optionally, a bridge 52 is provided at or on the hull 51. The watercraft 50 is preferably powered by hydrogen. For this purpose, the watercraft 50 can have a fuel cell 53. In the present case, the term “fuel cell” is understood to mean a galvanic cell that converts into electrical energy the chemical reaction energy of a continuously supplied fuel—in the present case, hydrogen—and of an oxidant—in the present case, oxygen. By means of the electrical energy obtained, an electric motor (not shown), for example, can be driven, which in turn drives a ship's screw for driving the watercraft 50.

A storage container 100 for storing liquid hydrogen is provided for supplying the fuel cell 53 with hydrogen. The storage container 100 is provided rotationally symmetrically with respect to a central axis or axis of symmetry 54 of the watercraft 50. To illustrate different alternatives, the storage container 100 is oriented vertically in FIG. 1, but horizontally in the subsequent figures. The storage container 100 can be arranged, for example, inside the hull 51, in particular within an engine room, on the bridge 52 or on a deck of the hull 51, said deck acting as a foundation 55. The axis of symmetry 54 is in particular oriented perpendicularly to a direction of gravity g. This means that the storage container 100 is in a horizontal or lying position.

In maritime applications, movement of the liquid hydrogen contained in the storage container 100 caused by swell must be expected. This sloshing results in the disadvantages mentioned above, in particular the mentioned entrainment.

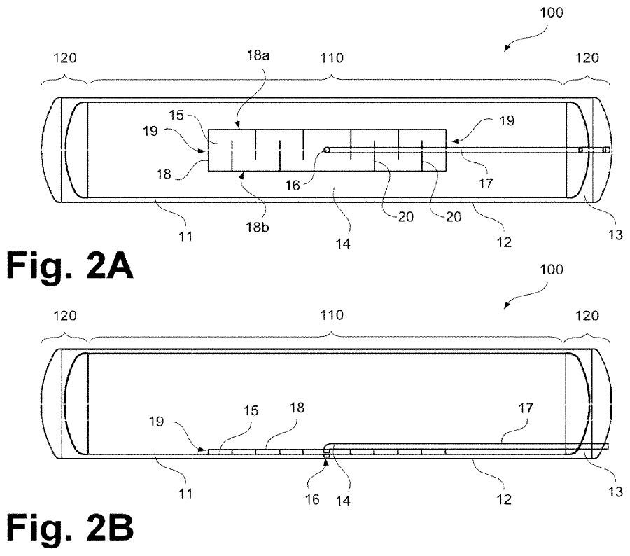

In FIGS. 2A and 2B, a storage container according to an embodiment of the invention is shown transparently in longitudinal and cross section and is designated as a whole by 100, wherein a longitudinal axis of the storage container 100 is arranged parallel to the plane of the page and parallel to the writing direction. In the views of FIGS. 2A and 2B, the storage container 100 is shown rotated by 90° about the longitudinal axis.

In the example illustrated here, the storage container 100 has a double wall which is formed from an inner wall 11 and an outer wall 12. An intermediate space 13 between the inner wall 11 and the outer wall 12 can, for example, be evacuated. The double wall surrounds a container interior 14, and an extraction region 15 for liquid is separated from the container interior 14. An extraction opening 16 for the liquid is arranged in the extraction region 15. In the example illustrated here, the extraction opening 16 is an inlet opening into an extraction line 17 which is guided out of the storage container 100.

As illustrated here, the extraction region 15 is separated from the container interior by means of a shielding wall 18 such that liquid through-openings are formed. The shielding wall is non-perforated. In the example specifically illustrated, the storage container 100 has a cylinder-shaped portion 110, and in at least a part of the cylinder-shaped portion 110, here in its central region, the shielding wall 18 is provided, by means of which a cylinder segment corresponding to the extraction region 15 is separated.

In the embodiment of the present invention illustrated here, the shielding wall 18 contacts the inner wall 11 of the storage container on two sides 18a, 18b arranged parallel to a central axis of the cylinder-shaped portion 110 (as illustrated in FIG. 2A) and is here in particular welded to said inner wall. At the front and rear, the cylinder segment or the extraction region 15 is connected to the rest of the container interior 14 via corresponding connecting openings 19.

As illustrated in FIG. 2A, the shielding wall 15 is connected to the inner wall 11 of the storage container by means of a plurality of mutually parallel fastening walls 20, and in the specific example illustrated here the fastening walls 20 are in the form of incomplete circle segments, define chambers located in the extraction region 15 and leave passages between the chambers clear alternately on the first and the second of the two sides arranged parallel to the central axis and in this way define an at least partially meandering interior of the cylinder segment 5.

The storage container as a whole is closed at both ends by hemispherical or dome-shaped portions 120.

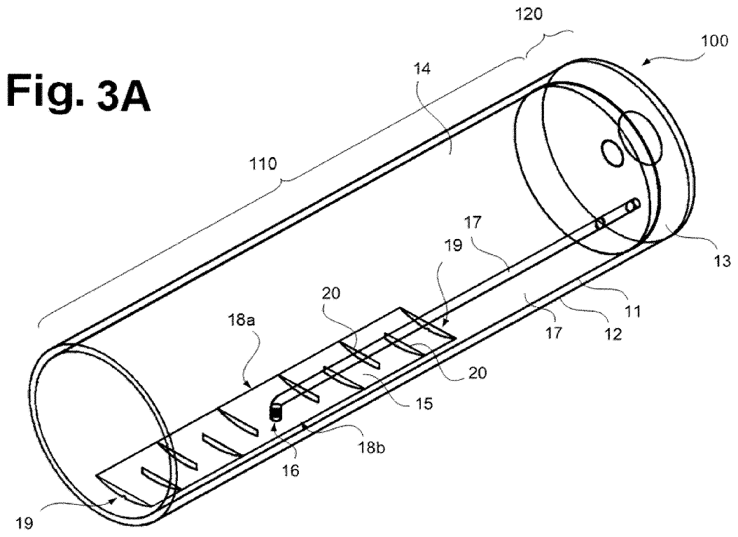

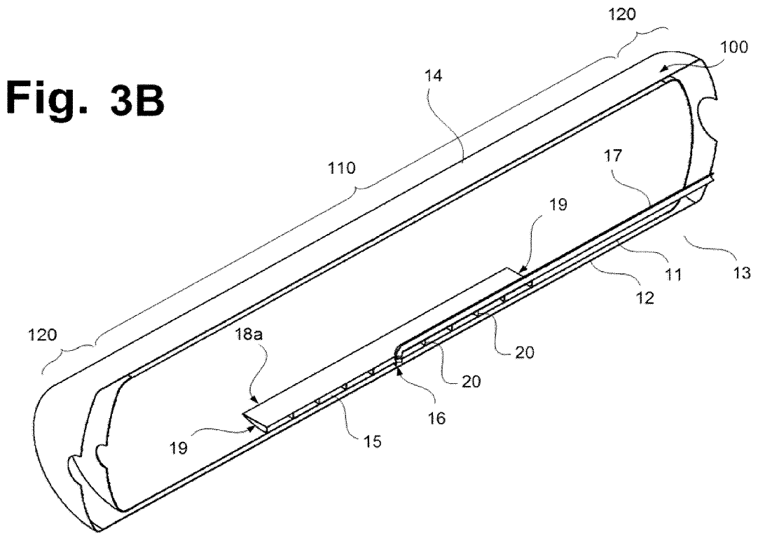

FIGS. 3A and 3B illustrate a storage container 100 according to an embodiment of the invention in a schematic perspective view, wherein the storage container 100 is shown with a transverse cut in FIG. 3A and with a longitudinal cut in FIG. 3B. Reference is made to the explanations for FIGS. 2A and 2B.

1. A storage container for a cryogenic liquid, comprising a container interior, in which an extraction region for the liquid is formed, wherein an extraction opening for the liquid is arranged in the extraction region, wherein the extraction region is separated from the container interior by means of an at least in portions non-perforated shielding wall such that liquid through-openings are kept clear.

2. The storage container according to claim 1, wherein the extraction opening is an inlet opening of an extraction line for the liquid, the extraction line being guided out of the storage container inside or outside the extraction region, either vertically downwards or to the side.

3. The storage container according to claim 2, wherein the extraction opening is a discharge opening from the storage container in the extraction region.

4. The storage container according to claim 1, which has a cylinder-shaped portion, wherein the shielding wall is provided in at least a part of the cylinder-shaped portion, and wherein the extraction region is separated, as a cylinder segment, from the container interior by means of the shielding wall.

5. (canceled)

6. The storage container according to claim 1, wherein the shielding wall is connected to a container wall of the storage container by means of a plurality of mutually parallel fastening walls.

7. The storage container according to claim 6, wherein the fastening walls are in the form of incomplete circle segments, define chambers arranged one behind the other and leave passages clear between the chambers.

8. The storage container according to claim 6, wherein the fastening walls define an at least partially meandering interior of the extraction region.

9. The storage container according to claim 1, the storage container being closed at both ends by hemispherical or dome-shaped portions.

10. The storage container according to claim 1, which has a double wall which is designed for vacuum insulation.

11. A watercraft having a storage container according to claim 1, wherein the cylinder-shaped portion storage container is arranged horizontally or vertically.

12. A method for storing a cryogenic liquid, in which a storage container according to claim 1 is used, in particular in a watercraft, wherein the cylinder-shaped portion storage container is arranged horizontally or vertically.

13. The storage container according to claim 4, wherein the shielding wall contacts the cylinder-shaped portion on two parallel sides.
